(19) United States
(12) Patent Application Publication
(10) Pub. No.: US 2003/0203061 A1
(43) Pub. Date: Oct. 30, 2003

(54) Mold cavity-defining die assembly to produce formed millwork products having interior stiffening ribs

(76) Inventor: Mohammed Peer Khan, Pittsburgh, PA (US)

Correspondence Address: Michael R. Swartz, Esq., 205 Royal Oak Avenue, Pittsburgh, PA, 15235, US

(21) Appl. No.: 10/135,721

(22) Filed: Apr. 30, 2002

(51) Int. Cl. B29B 9/00

(52) U.S. Cl. 425/20

(57) ABSTRACT

A mold cavity-defining die assembly includes lower and upper molds adapted to be disposed against one another. The lower mold has an inner surface defining an outer side of a mold cavity and forming an outside wall of a formed millwork product produced in the mold cavity. The upper mold supports an array of core members such that the core members protrude into the mold cavity so as to define an inner side of the mold cavity and form an inside wall and interior ribs of the product such that the inside wall and interior ribs together provide sufficient surface area to ensure that the product clings to the upper mold and core members and releases from the lower mold upon separation of the molds from one another.

### BACKGROUND OF THE INVENTION

1. Field of the Invention

The present invention generally relates to the manufacture of millwork products made of plastic, such as polyurethane, and, more particularly, is concerned with a mold cavity-defining die assembly for use in a molding apparatus to produce formed millwork products, such as window headers, incorporating interior stiffening ribs.

2. Description of the Prior Art

Due to the high cost of custom manufacture of wood and the persistent maintenance problems of wood in terms of rotting, cracking, warping, splintering and insect infestation, millwork for entry systems, window treatments, louvers, moldings, columns, balustraders and architectural enhancements made of plastic, such as polyurethane, is increasingly being utilized in both commercial and residential construction, as well as, in historical restoration. Millwork made of plastic, sometimes referred to as formed millwork, is easy to handle, saws cleanly for miter cuts, and can be applied with construction adhesives and/or nails and screws. Such millwork does not need sanding or sealing and can be patched with ordinary (non-solvent) wood fillers. Furthermore, such millwork is substantially maintenance free in that its white acrylic prime finish will not peel and it is UV-stabilized to resist sun fading and readily accepts latex paint. Such millwork has the feel, density, and workability of wood while avoiding the aforementioned problems associated with wood. For convenience in terminology used hereinafter, the terms millwork, pre-formed millwork, formed millwork, or plastic millwork refer to millwork made of a plastic material, such as polyurethane, and are used interchangeably hereinafter.

U.S. Pat. No. 6,280,178 to Mohammed Peer Khan, who is also the inventor of the present invention, discloses a molding apparatus for producing formed millwork products that has introduced certain innovations advantageous to the millwork manufacturing process, resulting in the achievement of an increase in the production, at lower unit costs, of certain types of millwork products having different shaped profiles. The inventor of this patented molding apparatus has now perceived a need for introduction of further innovation in the millwork manufacturing process. Specifically, innovation is needed to adapt the patented molding apparatus to produce other types of millwork products, in particular, ones commonly referred to in the industry as window headers, which can vary in their respective profile, widths and lengths. To adapt the patented molding apparatus to produce window headers, the innovation must ensure that the molded window header will cling to the upper, rather than the lower, mold upon separation of the molds from each other after completion of the molding process in order that the ejector mechanism associated with the upper mold can then be used to effect separation of the molded window header from the upper mold. Also, the innovation must ensure that the molded window header will have sufficient structural integrity for the application as well as to withstand the forces imposed on the window header by the ejector mechanism during separation of the window header from the upper mold.

### SUMMARY OF THE INVENTION

The present invention satisfies the aforementioned need for additional innovation in the millwork manufacturing process by providing a mold cavity-defining die assembly for use in a molding apparatus to produce formed millwork products, such as window headers, incorporating interior stiffening ribs. The present invention also provides a formed millwork window header having the interior stiffening ribs. The interior stiffening ribs together with an inside wall of the window header provide sufficient surface area in the window header in frictional contact with the upper mold to ensure that the window header will cling to the upper mold and release from the lower mold upon separation of the molds and will also provide the window header with sufficient structural integrity for the application as well as to withstand its ejection from the upper mold. The mold cavity-defining die assembly of the present invention thereby enhances the ability to consistently eject formed millwork products from the die assembly so as to enable an increase in production without increasing labor utilization and thus achieve production at lower unit costs.

Accordingly, the present invention is directed to a mold cavity-defining die assembly for use in a molding apparatus to produce formed millwork products. The die assembly comprises: (a) a first mold having an inner surface thereon defining an inner side of a mold cavity and forming an outside wall of a formed millwork product produced in the mold cavity; (b) a second mold adapted to be disposed against the first mold for producing the formed millwork product in the mold cavity formed between the first and second molds; (c) an array of core members spaced apart from one another and supported on the second mold such that the core members protrude into the mold cavity so as to define an opposite outer side of the mold cavity and form an inside wall of the formed millwork product and also form a plurality of spaced apart ribs interconnecting spaced portions of the inside wall of the product such that the inside wall and spaced ribs of the formed millwork product provide sufficient surface area in frictional contact with the second mold and core members to ensure that the formed millwork product will cling to the second mold and core members and release from the first mold upon separation of the first and second molds from one another; and (d) means for feeding a molding material from exteriorly of to and into the mold cavity.

The present invention also is directed to a formed millwork window header capable of being molded between a pair of opposing molds disposed against one another. The window header comprises: (a) an elongated housing having spaced opposite ends; (b) an outside wall defined on the housing having a predetermined decorative configuration; (c) an inside wall defined on the housing having a concave shape forming a recess extending between the opposite ends of the housing; and (d) a plurality of spaced apart interior ribs extending across the recess of the housing and interconnecting spaced apart opposite portions of the inside wall of the housing such that the interior ribs stiffen the housing so as to enable removal of the housing from the mold parts and further such that the inside wall and interior ribs together provide a sufficient surface area to ensure that the housing clings to a predetermined one of the molds and release from the other of the molds upon separation of the molds from one another.

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the following detailed description, reference will be made to the attached drawings in which:

FIG. 1 is a front outline of a mold cavity-defining die assembly of the present invention.

FIG. 2 is a cross-sectional view of the mold cavity-defining die assembly taken along line 2--2 of FIG. 1.

FIG. 3 is a cross-sectional view of a formed millwork product, namely a window header, produced using the die assembly of FIG. 2.

FIG. 4 is an enlarged plan view of a lower plate of a molding material metering or feeding unit of the die assembly.

FIG. 5 is a foreshortened bottom plan view of an upper mold of the die assembly as seen along line 5--5 of FIG. 2 after rotation clockwise ninety degrees but not showing the different core members supported by and projecting below the upper mold.

FIG. 6 is a foreshortened top plan view of a lower mold of the die assembly as seen along line 6--6 of FIG. 2 after rotation clockwise ninety degrees.

FIG. 7 is a view of the lower mold similar to that of FIG. 6 now showing core members in the form of adjustable end stop members installed at the opposite ends of the lower mold in a mold cavity defined by the lower mold of the die assembly.

FIG. 8 is a view of the lower mold similar to that of FIG. 7 now showing the window header produced in the mold cavity and the core members supported from the upper mold.

FIG. 9 is a view of the lower mold similar to that of FIG. 8 now showing the core members removed so as to expose the interior stiffening ribs of the window header.

FIG. 10 is a vertical sectional view of the die assembly taken along line 10--10 of FIG. 2 showing the upper and lower molds and the core members in the form of end stops and rib-forming core blocks in the mold cavity of the die assembly.

FIG. 11 is a perspective view of the window header produced by the die assembly of the present invention.

FIG. 12 is an enlarged vertical cross-sectional view of the window header taken along line 12--12 of FIG. 11 showing an end thereof.

FIG. 13 is another enlarged vertical cross-sectional view of the window header taken along line 13--13 of FIG. 11 showing one of the interior stiffening ribs therein.

FIG. 14 is a top plan view of a left one of the end stops of the die assembly.

FIG. 15 is a top plan view of a right one of the end stops of the die assembly.

FIG. 16 is a side elevational view of a center core block of the die assembly as seen along line 16--16 of FIG. 17.

FIG. 17 is a top plan view of the center core block as seen along line 17--17 of FIG. 16.

FIG. 18 is an end elevational view of the center core block as seen along line 18--18 of FIG. 16.

FIG. 19 is a side elevational view of a narrow standard core block of the die assembly.

FIG. 20 is a top plan view of the narrow standard core block as seen along line 20--20 of FIG. 19.

FIG. 21 is an end elevational view of the narrow standard core block as seen along line 21--21 of FIG. 19.

FIG. 22 is an opposite end elevational view of the narrow standard core block as seen along line 22--22 of FIG. 19.

FIG. 23 is a top plan view of a wide standard core block of the die assembly.

FIG. 24 is an end elevational view of the wide standard core block as seen along line 24--24 of FIG. 23.

FIG. 25 is a top plan view of a narrow slant core block of the die assembly.

FIG. 26 is an end elevational view of the narrow slant core block as seen along line 26--26 of FIG. 25.

FIG. 27 is a top plan view of a wide slant core block of the die assembly.

FIG. 28 is an end elevational view of the wide slant core block as seen along line 28--28 of FIG. 27.

### DETAILED DESCRIPTION OF THE INVENTION

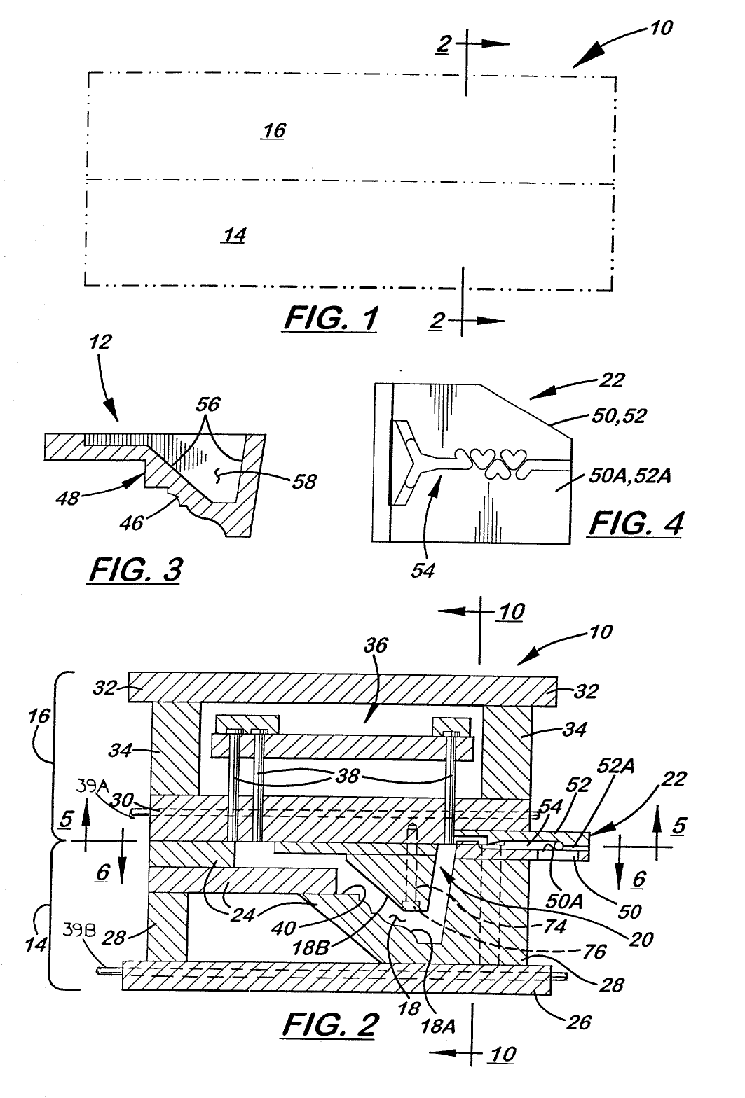

Referring to the drawings and particularly to FIGS. 1, 2, and 10, there is illustrated, in outline and sectional forms, a mold cavity-defining die assembly of the present invention, generally designated 10. The die assembly 10 can be used by a suitable conventional molding apparatus. The die assembly 10, particularly, is adapted for use by the molding apparatus disclosed in the aforecited U.S. Pat. No. 6,280,178 replacing the lower and upper composite mold/press units disclosed therein, so as to produce a formed millwork product, such as a window header 12, as seen in FIGS. 3, 9 and 11-13. The disclosure of the construction and operation of the molding apparatus of the aforecited patent is incorporated herein by reference thereto.

The die assembly 10 of the present invention basically includes a lower mold 14 and an upper mold 16 adapted to be disposed against the lower mold 14, during the operation of a normal molding cycle of the molding apparatus as described in the aforecited patent, so as to define a mold cavity 18 therebetween in which the formed millwork product 12 will be produced. The die assembly 10 also includes an array of core members 20 and a feeder unit 22 for feeding a molding material from exteriorly of the lower and upper molds 14, 16 into the mold cavity 18 for producing the product 12 in the mold cavity 18. Further, the lower mold 14 includes a lower mold part 24, a lower mounting plate 26 and means, such as in the form of spacers 28, for mounting the lower mold part 24 on the lower mounting plate 26. The upper mold 16 includes an upper mold part 30, an upper mounting plate 32, means, such as in the form of spacers 34, for mounting the upper mold part 30 on the upper mounting plate 32, and an ejector mechanism 36 supported above and by the upper mold part 30 and having a plurality of ejector rods 38 operable to eject the formed millwork product from the mold cavity 18. Still further, for cooling and controlling the temperature of the die assembly 10 due to the exothermic reaction of the molding material, the upper mold 16 includes a coolant flow path 39A defined through the upper mold part 16 and the lower mold 14 includes a coolant flow path 39B defined through the lower mounting plate 26.

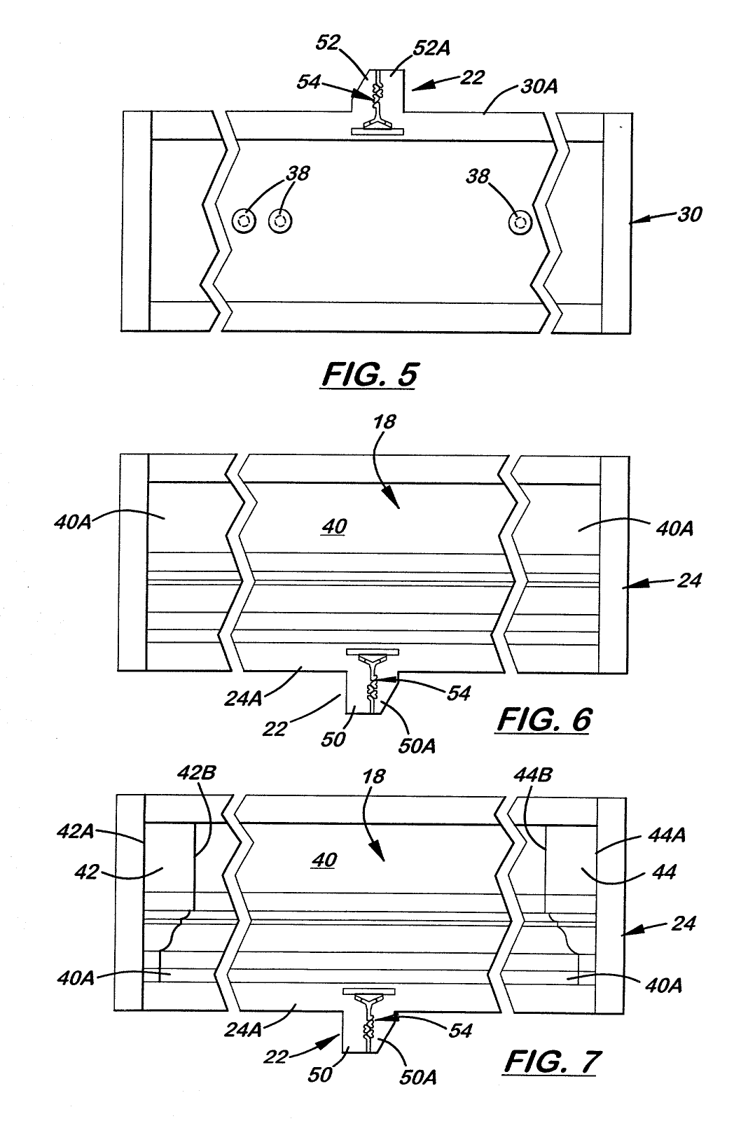

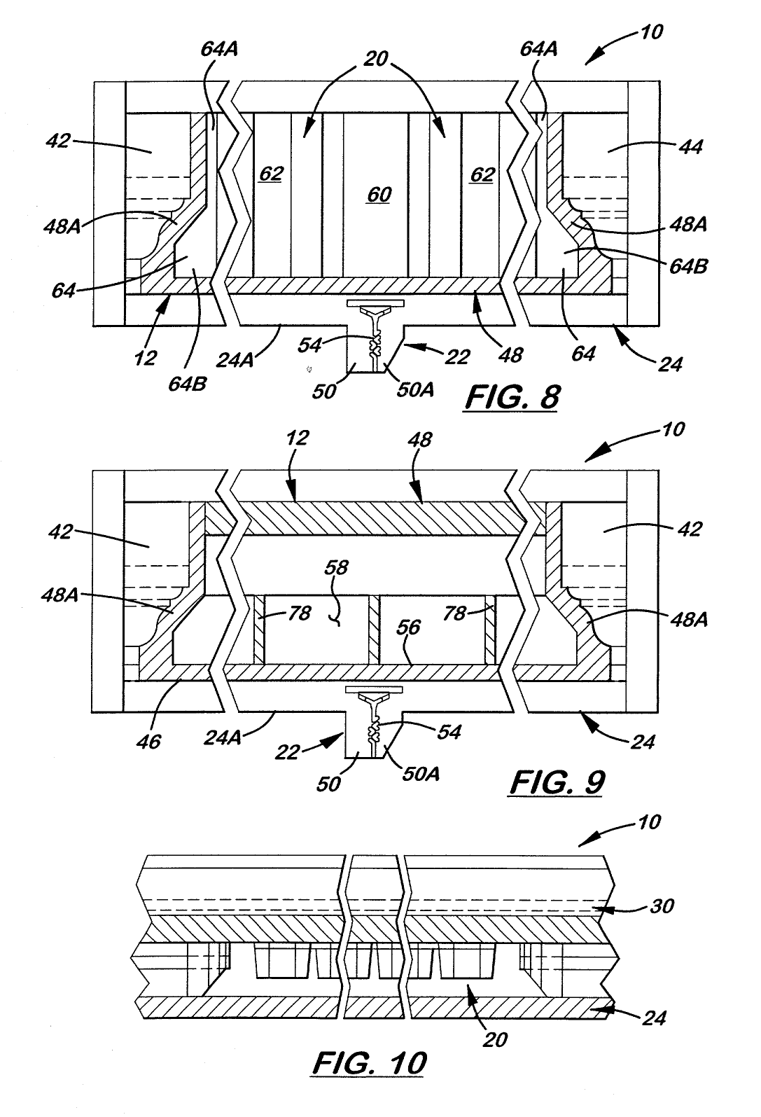

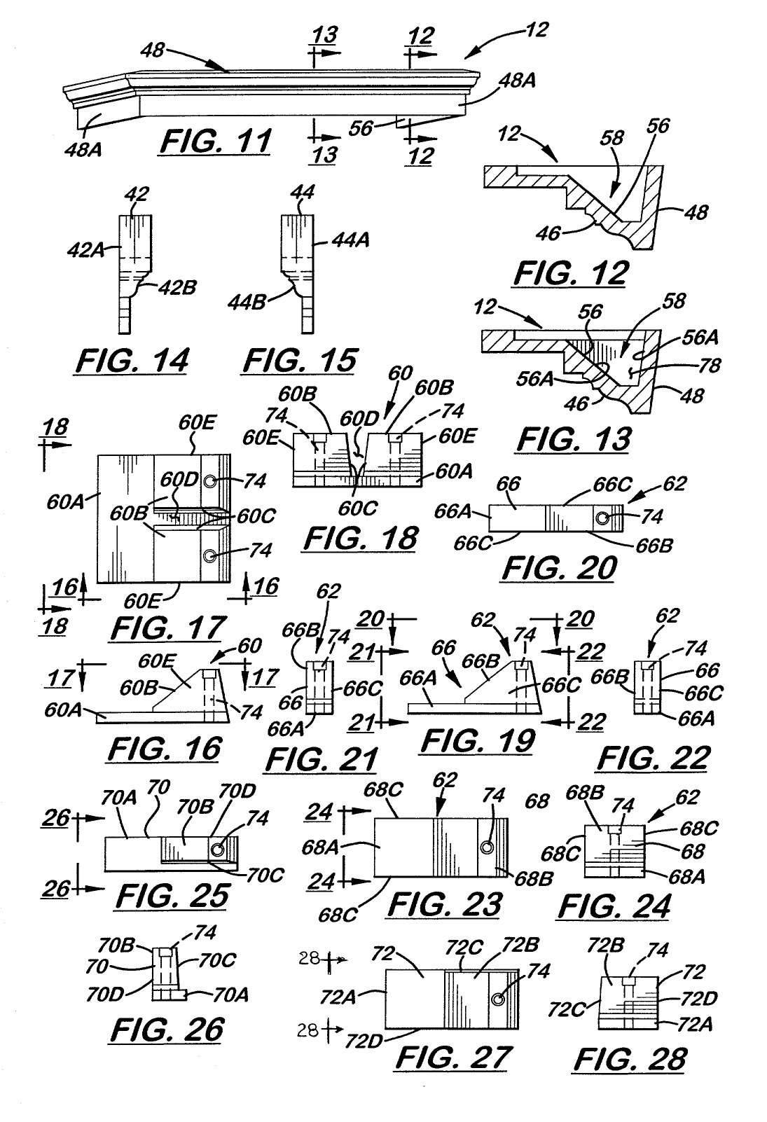

Referring to FIGS. 2 and 5-10, the lower mold part 24 of the lower mold 14 has an inner surface 40 and a pair of end stops 42, 44, as seen in FIGS. 7-10, 14 and 15, which together with the inner surface 40 define an outer side 18A of the mold cavity 18 and form an outside wall 46 of an elongated housing 48 of window header 12 produced in the mold cavity 18. The end stops 42, 44 have flat outer ends 42A, 44A which face toward the insides of the spacers 28 of the lower mold 14 and inner ends 42B, 44B which, like the inner surface 40, are shaped to provide the desired ornamental configuration of the outside wall 46 of the housing 48 of the window header 12. The end stops 42, 44 are adjustably mountable in any suitable manner on the inner surface 40 and at the opposite end portions 40A thereof so as to be able to change the spacing between the end stops 42, 44 for producing window headers 12 of different lengths. The upper mold part 30 of the upper mold 16 is adapted to be disposed or held against the lower mold part 24 during the producing of the window header 12 in the mold cavity 18.

Referring to FIGS. 2 and 4-9, the feeder unit 22 of the die assembly 10 includes lower and upper plates 50, 52 which are respectively attached to and project outwardly from the middle of front edges 24A, 30A of the lower and upper mold parts 24, 30. As best seen in FIG. 2, the lower and upper plates 50, 52 of the feeder unit 22 are placed together with their facing surfaces 50A, 52A in a flush contacting relationship with one another, when the lower and upper molds 14, 16 are placed against one another, so as to define a passage 54 between the plates 50, 52 through which the molding material is fed or injected from exteriorly of to between the lower and upper mold parts 24, 30 and into the mold cavity 18.

Referring to FIGS. 2 and 7-10, the array of core members 20 are supported by the upper mold part 24 of the upper mold 16 such that they protrude into the mold cavity 18 so as to define an opposite, or inner, side 18B of the mold cavity 18, relative to the one or outer side 18A defined by the lower mold part 24. The array of core members 20 so supported thereby form an inside wall 56 of the elongated housing 48 of the window header 12 and a recess 58 defined by the concave shape of the inside wall 56.

More particularly, as seen in FIGS. 7-10 and 14-28, the array of core members 20 includes a center core block 60, as seen in FIGS. 8, 10 and 16-18, a plurality of intermediate core blocks 62, as seen in FIGS. 8, 10 and 19-28, and end core blocks 64, as seen in FIGS. 8 and 10. The plurality of intermediate core blocks 62 includes narrow and wide standard core blocks 66, 68, as seen in FIGS. 19-24 and narrow and wide slanted core blocks 70, 72, as seen in FIGS. 25-28. Each of the center core block 60, end core blocks 64, narrow and wide standard blocks 66, 68, and narrow and wide slanted core blocks 70, 72 has a substantially flat base portion 60A, 64A, 66A, 68A, 70A, 72A and a body portion 60B, 64B, 66B, 70B, 72B attached to and protruding outwardly from one side of the respective base portion 60A, 64A, 66A, 68A, 70A, 72A and has a cross-sectional shape the same as the cross-sectional shape of the recess 58 formed by the array of core members 20 in the housing 48 of the window header 12. Also, an aperture 74 is defined through each of the respective body portion 60B, 64B, 66B, 70B, 72B and base portion 60A, 64A, 66A, 68A, 70A, 72A of the core members such that a conventional fastener 76, as seen in FIG. 2, can be used to attach each of the core members of a desired array 20 thereof to the upper mold part 30.

Different arrangements of the core members can be employed in the array 20 thereof so as to form a desired number of spaced apart interior stiffening ribs 78 in the housing 44 of the window header 12. The ribs 78 are formed so as to interconnect oppositely spaced portions of the inside wall 56 of the housing 48 of the window header 12 and extend across the recess 58 defined by the concave shape of the inside wall 56. More specifically, the center core member 60 is supported by the upper mold part 30 as to be disposed intermediately of the mold cavity 18. As best seen in FIGS. 16-18, the body portion 60B of the center core block 60 has at least a pair of interior walls 60C spaced apart from one another and defining a rib-forming space 60D between the interior walls 60C. Preferably, the interior walls 60C flare away from one another going away from the base portion 60A so as to be capable of forming one of the ribs 78 with a trapezoidal cross-sectional configuration that facilitates removal of the rib 78 from between the interior walls 60C during ejection of the window header 12 from the upper mold 16. The central core member 60 further has a pair of opposite end walls 60E defined in planes extending parallel with one another. The opposite end core blocks 64 are spaced from the opposite end walls 60E of the central core block.

As best seen in FIGS. 19-28, the narrow and wide standard core blocks 66, 68 have respective pairs of opposite end walls 66C, 68C defined in planes parallel to one another such that selected ones of the standard core blocks 66, 68 can be placed flush against one of the end walls 60E of the central core member 60. As is readily apparent by a comparison of FIG. 20 with FIG. 23, the narrow standard core block 66 is narrower in width than the wider standard core block 68, or conversely, the wide standard core block 68 is wider in width than the narrow standard core block 66. Any desired number of these standard core blocks 66, 68 may be used.

As best seen in FIGS. 25-28, the narrow and side slant core blocks 70, 72 have respective pairs of opposite end walls 70C, 70D and 72C, 72D wherein one end wall 70C, 72C of the respective slant core blocks 70, 72 is a slanted end wall relative to a vertical plane such that a pair of the slant core blocks 70, 72 can be placed in an adjacent spaced apart relationship such that the slanted end walls 70C, 72C of the slanted core blocks 70, 72 can define a rib-forming space therebetween. The other end wall 70D, 72D of the respective slant core blocks 70, 72 is a vertical end wall defining a plane generally parallel with the planes of the other like end walls such that selected ones of the slant core blocks 70, 72 can be placed flush against one of the end walls 60E of the central core member 60. As is readily apparent by a comparison of FIG. 25 with FIG. 27, the narrow slanted core block 70 is narrower in width than the wider slanted core block 72, or conversely, the wide slanted core block 72 is wider in width than the narrow slanted core block 70. Any desired number of these slanted core blocks 70, 72 may be used.

Referring to FIGS. 3, 9 and 11-13, there is illustrated the formed millwork window header 12 of the present invention which is molded between the pair of opposing mold parts 24, 30 of the die assembly 10 when disposed against one another. The window header 12 basically includes the elongated housing 48 having spaced opposite ends 48A, the outside wall 46 defined on the housing 48 having a predetermined decorative configuration, the inside wall 56 defined on the housing 48 having the concave shape forming the recess 58 extending between the opposite ends 48A of the housing 48, and the plurality of spaced apart interior ribs 78 extending across the recess 58 of the housing 48 and interconnecting the spaced apart portions 56A of the inside wall 56 of the housing 48. The interior ribs 78 stiffen the housing 48 so as to enable removal of the housing 48 from the mold parts 24, 30 and further such that the inside wall 56 and interior ribs 78 together provide a sufficient surface area to ensure that the housing 48 clings to the upper mold part 30 and ribs 78 and releases from the lower mold part 24 upon separation of the molds 14, 16 from one another.

It is thought that the present invention and its advantages will be understood from the foregoing description and it will be apparent that various changes may be made thereto without departing from the spirit and scope of the invention or sacrificing all of its material advantages, the form hereinbefore described being merely preferred or exemplary embodiment thereof.

I claim:

1. A mold cavity-defining die assembly for use in a molding apparatus to produce a formed millwork product, said die assembly comprising:
(a) a first mold having an inner surface thereon defining an outer side of a mold cavity and forming an outside wall of a formed millwork product produced in said mold cavity;
(b) a second mold adapted to be disposed against said first mold for producing the formed millwork product in said mold cavity formed between said first and second molds;
(c) an array of core members spaced apart from one another and supported on said second mold such that said core members protrude into said mold cavity so as to define an opposite inner side of said mold cavity and form an inside wall of the formed millwork product and also form a plurality of spaced apart ribs interconnecting spaced portions of the inside wall of the product such that the inside wall and spaced ribs of the formed millwork product provide sufficient surface area in frictional contact with said second mold and core members to ensure that the formed millwork product will cling to said second mold and core members and release from said first mold upon separation of said first and second molds from one another; and
(d) means for feeding a molding material from exteriorly of and into said mold cavity.

2. The assembly as recited in claim 1, wherein said first mold includes a pair of end stops each supported on said inner surface of said first mold such that together said inner surface and end stops define said outer side of said mold cavity that forms a desired ornamental shape of the outside wall of the formed millwork product.

3. The assembly as recited in claim 1, wherein said array of core members include a center core block supported by said second mold intermediately within said mold cavity, said center core block having a pair of opposite ends and at least a pair of interior walls spaced from said opposite ends and spaced apart from one another and defining a rib-forming space between said interior walls.

4. The assembly as recited in claim 3, wherein said interior walls of said central core block flare away from one another so as to be capable of forming one of the ribs with a trapezoidal cross-sectional configuration.

5. The assembly as recited in claim 3, wherein said array of core members includes a pair of opposite end core blocks spaced from said opposite ends of said central core block.

6. The assembly as recited in claim 5, wherein said first mold includes a pair of end stops spaced from said end core blocks, each of said end stops being supported on said inner surface of said first mold such that together said inner surface and end stops define said outer side of said mold cavity that forms a desired ornamental shape of the outside wall of the formed millwork product.

7. The assembly as recited in claim 6, wherein said end stops are adjustably mountable on said inner surface of said first mold and at opposite end portions thereof so as to be able to change spacing between said end stops for producing formed millwork products of different lengths.

8. The assembly as recited in claim 3, wherein:
said central core member has a pair of opposite end walls defined in planes generally parallel to one another; and
said core members further include a plurality of standard core blocks each having opposite end walls defined in planes generally parallel to one another such that selected ones of said standard core blocks can be placed with one of said end walls thereof flush against one of said end walls of said central core member.

9. The assembly as recited in claim 8, wherein at least one of said standard core blocks is narrower in width than another of said standard core blocks.

10. The assembly as recited in claim 8, wherein at least one of said standard core blocks is wider in width than another of said standard core blocks.

11. The assembly as recited in claim 3, wherein said core members further include a plurality of slant core blocks each having a pair of opposite end walls wherein one of said opposite end walls is a slanted end wall such that a pair of said slant core blocks can be placed in an adjacent spaced apart relationship with one another such that said slanted end walls of said adjacent slanted core blocks define a rib-forming space therebetween.

12. The assembly as recited in claim 11, wherein at least one of said slant core blocks is narrower in width than another of said slant core blocks.

13. The assembly as recited in claim 11, wherein at least one of said slant core blocks is wider in width than another of said slant core blocks.

14. The assembly as recited in claim 11, wherein the other of said opposite end walls of said slant core blocks define planes that are parallel to one another such that selected ones of said slant core blocks at can be placed with said other end walls thereof flush against one of said end walls of said central core member.

15. A mold cavity-defining die assembly for use in a molding apparatus to produce a formed millwork product, said die assembly comprising:
(a) a lower mold including a lower mounting plate, a lower mold part and means for mounting said lower mold part on said lower mounting plate, said lower mold part having an inner surface thereon defining an outer side of a mold cavity and forming an outside wall of a formed millwork product produced in said mold cavity;
(b) an upper mold including an upper mounting plate, an upper mold part and means for mounting said upper mold part on said upper mounting plate, said upper mold part adapted to be disposed against said lower mold part for producing a formed millwork product in said mold cavity formed between said first and second mold parts;
(c) an array of core members spaced apart from one another and supported on said upper mold part such that said core members protrude into said mold cavity so as to define an opposite inner side of said mold cavity and form an inside wall of the formed millwork product and also form a plurality of spaced apart ribs interconnecting spaced portions of the inside wall of the product such that the inside wall and spaced apart ribs of the formed millwork product provide sufficient surface area in frictional contact with said upper mold part and core members to ensure that the formed millwork product will cling to said upper mold part and core members and release from said lower mold part upon separation of said lower and upper mold parts from one another; and
(d) means for feeding a molding material from exteriorly of to between said lower and upper mold parts into said mold cavity.

16. The assembly as recited in claim 15, wherein said lower mold part includes a pair of end stops each supported on said inner surface of said lower mold part such that together said inner surface and end stops define said outer side of said mold cavity that forms a desired ornamental shape of the outside wall of the formed millwork product.

17. The assembly as recited in claim 15, wherein said array of core members includes a pair of opposite end core blocks spaced from said opposite ends of said central core block.

18. The assembly as recited in claim 17, wherein said lower mold part includes a pair of end stops spaced from said end core blocks, each of said end stops being supported on said inner surface of said lower mold part such that together said inner surface and end stops define said outer side of said mold cavity that forms a desired ornamental shape of the outside wall of the formed millwork product.

19. The assembly as recited in claim 18, wherein said end stops are adjustably mountable on said inner surface of said lower mold part and at opposite end portions thereof so as to be able to change spacing between said end stops for producing formed millwork products of different lengths.

20. The assembly as recited in claim 15, wherein said array of core members includes a center core block supported by said upper mold part intermediately within said mold cavity, said center core block having a pair of opposite ends and at least a pair of interior walls spaced from said opposite ends and spaced apart from one another and defining a rib-forming space between said interior walls.

21. The assembly as recited in claim 20, wherein said interior walls of said central core block flare away from one another so as to be capable of forming one of the ribs with a trapezoidal cross-sectional configuration.

22. The assembly as recited in claim 20, wherein:
said central core member has a pair of opposite end walls defined in planes generally parallel to one another; and
said core members further include a plurality of standard core blocks each having opposite end walls defined in planes generally parallel to one another such that selected ones of said standard core blocks can be placed with one of said end walls thereof flush against one of said end walls of said central core member.

23. The assembly as recited in claim 22, wherein at least one of said standard core blocks is narrower in width than another of said standard core blocks.

24. The assembly as recited in claim 22, wherein at least one of said standard core blocks is wider in width than another of said standard core blocks.

25. The assembly as recited in claim 20, wherein said core members further include a plurality of slant core blocks each having a pair of opposite end walls wherein one of said opposite end walls is a slanted end wall such that a pair of said slant core blocks can be placed in an adjacent spaced apart relationship with one another such that said slanted end walls of said adjacent slanted core blocks define a rib-forming space therebetween.

26. The assembly as recited in claim 25, wherein at least one of said slant core blocks is narrower in width than another of said slant core blocks.

27. The assembly as recited in claim 25, wherein at least one of said slant core blocks is wider in width than another of said slant core blocks.

28. The assembly as recited in claim 25, wherein the other of said opposite end walls of each of said slant core blocks define planes that are parallel to one another such that selected ones of said slant core blocks at can be placed with said other end walls thereof flush against one of said end walls of said central core member.

29. The assembly as recited in claim 15, further comprising:
a plurality of ejector rods supported by said upper mold.

30. A formed millwork window header capable of being molded between a pair of opposing mold parts disposed against one another, said window header comprising:
(a) an elongated housing having spaced opposite ends;
(b) an outside wall defined on said housing having a predetermined decorative configuration;
(c) an inside wall defined on said housing having a concave shape forming a recess extending between said opposite ends of said housing; and
(d) at least one interior rib extending across said recess of said housing and interconnecting opposite spaced apart portions of said inside wall of said housing such that said interior rib stiffen said housing so as to enable removal of said housing from the mold parts and further such that said inside wall and interior rib together provide a sufficient surface area to ensure that said housing clings to a predetermined one of the molds and release from the other of the molds upon separation of the molds from one another.
